(19) United States
(12) Patent Application Publication
(10) Pub. No.: US 2011/0185166 A1
(43) Pub. Date: Jul. 28, 2011

(54) Slider Control for Security Grouping and Enforcement

(75) Inventors: Kannan C. IYER, Sammamish, WA (US); Ozan Eren BILGEN, Seattle, WA (US); Subramanian CHANDRASEKARAN, Bellevue, WA (US); Lingan Satkunanathan, Kirkland, WA (US); Eric B. Watson, Redmond, WA (US)

(73) Assignee: MICROSOFT CORPORATION, Redmond, WA (US)

(21) Appl. No.: 12/695,829

(22) Filed: Jan. 28, 2010

(51) Int. Cl. G06F 9/00; G06F 15/177

(52) U.S. Cl. 713/100; 713/166; 709/224

(57) ABSTRACT

A group of security functions may be configured and managed by organizing the security functions and their features into a ranked list and made available through an administrative console. The ranked list may represent various levels of security from which a user may select. Once selected, the security functions may be configured according to the selected level. The console may determine a current security level by analyzing the configuration or status of each of the security functions and presenting a single status level from the ranked list determined by the least secure setting of the various security functions.

### BACKGROUND

Configuring and setting security systems for computer networks can be a complex and difficult task. For non-security experts, properly configuring the many interdependent security systems that may protect even a small network can be daunting.

### SUMMARY

A group of security functions may be configured and managed by organizing the security functions and their features into a ranked list and made available through an administrative console. The ranked list may represent various levels of security from which a user may select. Once selected, the security functions may be configured according to the selected level. Each security function may have one or more security components that operate to perform the security function. The console may determine a current security level by analyzing the configuration or status of each of the security functions and presenting a single status level from the ranked list determined by the least secure setting of the various security functions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a network environment in which a security management system may operate.

FIG. 2 is a diagram illustration of an embodiment showing a table with security systems and security levels.

FIG. 3 is a diagram illustration of an embodiment showing a user interface for a security console.

FIG. 4 is a flowchart illustration of an embodiment showing a method for managing security.

### DETAILED DESCRIPTION

A security management system may manage several security systems, applications, functions, and features to create a unified and secure computing environment. The system may present an administrator with a single slider or other user interface mechanism that may illustrate the current security level and allow the user to configure the various security systems to meet predefined levels of security.

The security management system may be capable of configuring and managing many different security functions, including stand-alone security applications, operating system functions, configuration of network devices, application settings, configuration files, or other software, hardware, and firmware components that may affect the security of a computer network.

The various security components may be organized into a ranked list of functions, each of the functions being defined by one or more components and settings that have been pre-selected and organized by a security expert. The ranked list may operate as a measure of security level for the network being protected, and may be presented to a network administrator with a slider or other user interface mechanism.

The user interface mechanism may present a current security level which may be determined by analyzing all of the managed security components, determining the settings or configuration of those components, and determining an overall security setting. The overall security setting may represent the lowest security setting that can be achieved with the current settings.

The displayed security level may be determined by querying or examining all of the security components. Each of the security components may have separate user interfaces and separate mechanisms by which an administrator or user may change the settings, even after the security management system may have configured the security component. Because of this, the security management system may determine the actual security setting by obtaining actual configuration data from the security components directly.

The user interface mechanism may be one mechanism by which the security components may be configured. A user may change the overall security setting by changing the slider to a new level. Once the slider is changed, all of the various security components may be changed to reflect the new level.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, or otherwise processed in a suitable manner and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

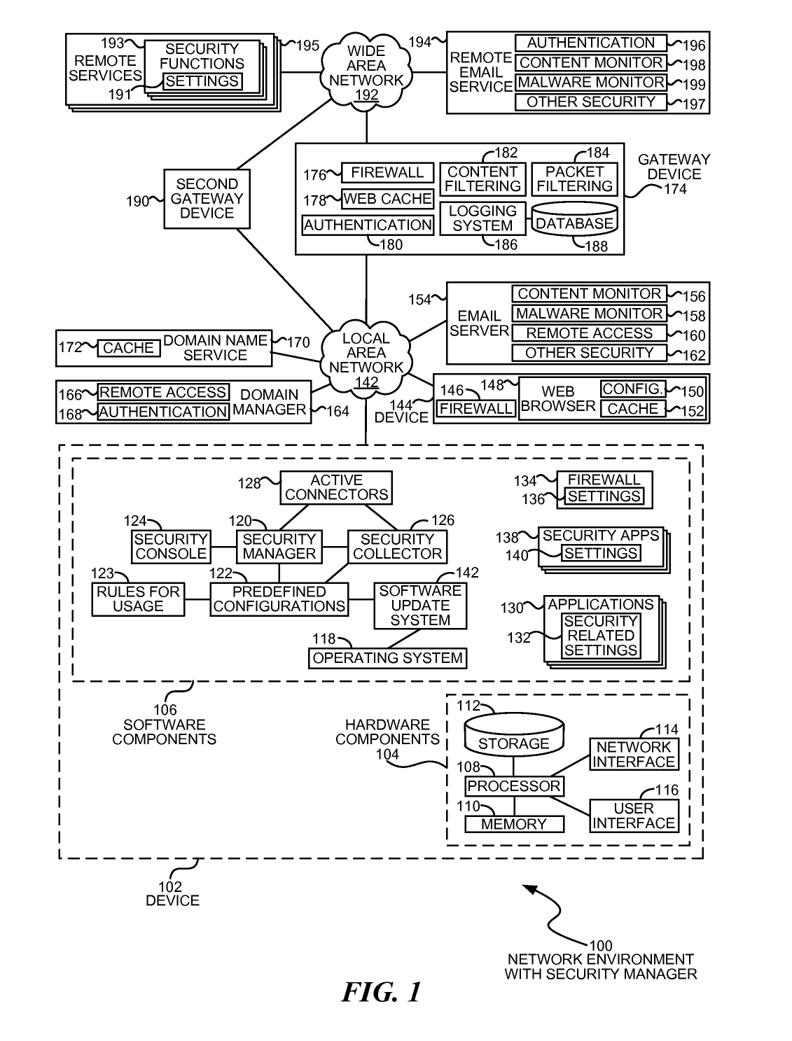

FIG. 1 is a diagram of an embodiment 100, showing a network environment with a security management system. Embodiment 100 is an example of a local area network in which a security management system may configure and manage various security components inside and outside the local area network.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 may illustrate a simplified local area network that may represent a computer network in a home or business. The network may have several different devices connected in a local area network, and may also use remote services that are located on the Internet or other wide area network.

A computer network may be vulnerable on many different fronts, which may include malware infestations, unwanted email or other communication, active attacks against the network such as denial of service attacks, unwanted content such as pornography, and many others. The vulnerabilities may include individual applications such as web browsers, services provided in the network such as email processing and Domain Name Services, network infrastructure such as gateways and routers, and many other components.

An effective security management strategy may coordinate many different applications, services, hardware and firmware settings, and other components into a cohesive, coordinated system for addressing specific security threats. The threats may vary based on the type of computer network and the services provided by that network. For example, a network that exposes a web interface may be vulnerable to certain types of attacks that other networks without a web interface may not experience.

The complexity of the security management is compounded by the ever changing threats. Different types of security threats are discovered on a daily basis by security professionals who monitor such activity, and manufacturers of software and hardware regularly provide updates to combat threats as they are discovered.

In many cases, two or more different components may work together to address a specific security threat. In some cases, the components may operate as two or more redundant layers of security. In other cases, the components may operate in conjunction to address a specific threat.

For example, many networks are configured with one or more gateway devices that may process some or all of the incoming and outgoing communications to the Internet. The network may also be configured with firewall applications on each of the various devices within the local area network, and the firewall applications may be configured to provide many of the same filters and processing that the gateway devices may provide.

In another example, an email threat prevention system may employ many different security components, including malware analysis, transport security components such as sender and recipient authentication, packet filtering, and other components. Each of the various components may be configured separately but may operate cooperatively to address various security vulnerabilities of email systems.

A generally trained information technologies administrator may not understand the complexities of computer network security and be competent to properly configure the large number of security component to effectively deal with the ever changing threats. In many cases, the information technologies generalist may be capable of understanding the larger picture of the various threats to which a network may be exposed, but not have the detailed knowledge or ability to configure all of the security components to address the threat.

A security specialist may define the security functions and the settings for security components to perform the functions. The security specialist may further organize the security functions into a ranked list and may provide predefined configurations and rules for usage so that the information technologies generalist may merely select a desired security level for the security management system to implement.

The security management system described in embodiment 100 illustrates one mechanism by which an administrator may configure the security components that affect a network environment in a simplified manner. The administrator may be able to configure one or more of the components separately and independently, and the security management system may reflect those changes in the system's user interface.

The security management system may use a simple slider mechanism or other user interface mechanism to present the security status for the network and allow the administrator to configure the security components in a single step. The position of the slider as shown in the user interface may reflect the security status of the network based on actual configuration settings that were detected from the security components. By changing the slider, the administrator may cause the security management system to configure all of the various security components to meet the new security level.

The security management system may have a hierarchy or ranked list of security functions. The highest security level may be the level at which all of the security functions are enabled and configured, and lower security levels may be ordered by removing one or more security functions from the list. An example of such a hierarchy is presented in embodiment 200 later in this specification.

Each security function may address a specific threat or perform a general security function. Each security function may be performed by one or more security components which may be configured to perform the security function.

Throughout this specification and claims, the term “security component” may be any configurable item that may perform a security function. For example, a security component may be a security application or service that performs an operation, such as scanning for viruses or malware, operating as a firewall or filter for network connections, or analyzing messages for prohibited or dangerous content. In another example, a security component may be a setting or option in an application, where the setting or option may affect the security of the application or device on which it operates. For example, a web browser may have various options that enable or disable security functions.

In some cases, the security component may not be labeled or identified specifically as a security component, but the misconfiguration of the item may have an impact on security. For example, a Domain Name Service (DNS) server may be configured to process certain operations from authenticated users. Such a configuration may not be labeled as a security setting, but such a configuration may minimize certain attacks from outside systems, for example.

Throughout this specification and claims, the term “security function” may refer to a type of threat or security objective. The security function may be performed by multiple security components in some cases, and in some cases, a single security component may perform the entire security function. A security function may be defined so that a user may easily identify and manage security components that perform the function. A user may be able to turn on or off a security function using a user interface mechanism, and a security management system may configure all of the related components to deliver the security function.

A device 102 may operate some or all of the parts of a security management system. In embodiment 100, the entire security management system may be performed by the device 102 but other embodiments may separate different portions to different devices.

The device 102 is illustrated as a conventional computing device, such as a desktop or server computer. In some embodiments, the device 102 may be a portable device, such as a laptop or netbook computer, personal digital assistant, cellular telephone, or other device. In other embodiments, the device 102 may be a game console, network appliance, network routing device, or any other device capable of performing the functions described.

The device 102 is illustrated as having hardware components 104 and software components 106. The distinction between the various components is merely as an example, and some embodiments may implement different features in hardware, firmware, or software.

The hardware components 104 may include a processor 108, random access memory 110, and nonvolatile storage 112. The processor 108 may also be connected to a network interface 114 and a user interface 118.

The software components 106 may include an operating system 118 on which various applications may operate.

A security manager 120 may operate as the central portion of a security management system. The security manager 120 may perform many of the management aspects of security components, including determining the current security status and applying configurations to different security components based on input from a user. The security manager 120 may also determine which security settings may be appropriate for certain conditions, as defined in a set of rules.

The security manager 120 may use a set of predefined configurations 122 and rules for usage 123 that may defined the various settings for security components in different applications. The predefined configurations 122 may contain the various settings for each of the security components under management by the security manager 120.

The rules for usage 123 may define the conditions under which the various configurations may be deployed. For example, the rules may define a network connection configuration that may be capable of deploying certain levels of security. An example may be to permit certain functions when a hardware gateway is present but to deny certain functions when such a gateway is not present.

The security console 124 may generate a user interface through which the security components may be managed. An example of such a user interface is presented as embodiment 300 later in this specification. The security console 124 may have various descriptions of the security levels, graphical representations of the security components, and listings of the various security functions provided by the security components. The security console 124 may include a slider or other user interface mechanism that may display the current security level for the network. In some embodiments, the slider or other user interface mechanism may be used to select a security level that may be deployed by the security manager 120.

A security collector 126 may communicate with the various security components to determine the security settings. The security collector 126 may use various active connectors 128 to gather the security information. The active connectors 128 may be agents, routines, functions, applications, or other mechanisms that may communicate with an application configuration file, perform a query to a security component, or use other mechanisms to determine settings for a security component. The security connector 126 may perform similar operations as well as schedule and coordinate the actions of the active connectors 128.

In some embodiments, a software update system 142 may update the predefined configurations 122 and the rules of usage 123 on a periodic or on demand basis. Some embodiments may receive changes that may be pushed from a remote server, while other embodiments may request changes on a regular basis.

Some security components may be operating locally on the device 102 as well as other devices on the local area network 142. For example, applications 130 may have various security related settings 132. The applications 130 may be any type of application for which a setting may affect security. For example, a word processing program may have settings that permit or deny execution of macros, or may permit or deny opening files downloaded from unknown sources. Such settings may be considered security settings in some instances. Other applications may have similar settings.

Many devices may have a local firewall 134. The local firewall 134 may have many security related settings 136. In many cases, a firewall 134 may be configured to open or close various ports on a network connection. Open ports may permit communications for certain protocols, while closed ports may deny those communications.

The firewall settings 136 may be an example of security component settings that may be changed for each security level. From one security level to the next, different security functions may be turned on or off. Each of those functions may have certain ports that are opened or closed to allow the security function to operate. In such an example, each security function may include firewall settings that are different for each security function.

Another example of security components may be various security related applications 138 and the respective settings 140. The security related applications may be any application that performs one or more security related functions. For example, a malware scanner may be a typical security related application. The malware scanner may be configurable to scan email messages in an email application, files downloaded from the Internet in a web browser application, and various files opened or manipulated by other applications. As such, the malware scanner may be configured to support different security functions or different levels of security.

The security manager 120 may manage security components on various devices attached to a local area network 142. In some cases, the devices may be client devices, such as client device 144. Client device 144 may be any type of computing device attached to the network 142, such as a desktop computer, server computer, laptop computer, game console, or other device, including mobile devices such as cellular telephones.

The client device 144 may have a firewall 146, as well as a web browser 148. The web browser 148 may have various configuration settings 150 as well as a cache 152 that may be configured to store or not store various information collected from the Internet and the user's actions. The various security components on the client device 144 may be monitored, changed, and managed by the security manager 120.

The local area network 142 may have several server devices, including an email server 154. The email server 154 may have many different types of security components, each with configurable settings. The email server 154 may have several security components, including a content monitoring function 156, malware monitoring function 158, remote access capabilities 160, and other security components 162. Each of the various email security components may be separately configured and managed to address specific security functions.

Many local area networks may have a domain manager 164, which may be a server that may provide authentication services 168. The authentication services 168 may authenticate various credentials provided by users, devices, or services to gain access to applications, devices, services, or other components. The authentication services 168 may be used to provide remote access services 166 to users from outside the local area network 142, such as users that connect using a virtual private network (VPN) or other connection scheme.

A Domain Name Service (DNS) server 170 may be another server within the local area network 142. The DNS server 170 may provide name services and lookup services to devices inside or outside the local area network 142. In many cases, a DNS server 170 may have a cache 172 that may contain addresses that have been previously looked up or that have been received from other servers, including the domain manager 164.

In many security management systems, the DNS server 170 may be configured in different manners to minimize exposure to certain threats. For example, the cache 172 may be configured to be refreshed at short intervals to thwart DNS cache corruption attacks. In another example, DNS requests from outside the local area network 142 may be filtered or in some cases authenticated to minimize exposure to denial of service attacks on the DNS server 170.

A gateway device 174 may provide various front end or edge security services. The gateway device 174 may provide a link between the local area network 142 and a wide area network 192. In many instances, the gateway device 174 may provide the first line of defense from attacks that originate from the wide area network 192.

The gateway device 174 may provide a firewall 176 that may open or close various ports for communications. Many protocols may be configured to communicate using specific ports on a network connection, and the firewall 176 may operate in a similar manner as the local firewalls on the various devices, such as devices 102 or 144.

The gateway device 174 may include a web cache 178. The web cache 178 may store information that is received from the wide area network 192, and may be used to respond to identical requests from the same or other devices within the local area network 142. For example, a user on one device may request a web page from a remote server. The web page may be stored in the web cache 178 and used to respond to a second user's request for the same web page. In some implementations, the web cache 178 may significantly reduce the amount of data retrieved from the wide area network 192 and increase response times for the second and subsequent request.

Authentication services 180 may be employed in some gateway devices 174. The authentication services 180 may allow some or all of the connections through the gateway 174 after a user, device, or service has presented appropriate credentials. In some embodiments, the authentication service 180 may operate with a domain manager 164 or other authentication system to verify credentials.

Content filtering 182 may be performed by the gateway device 174. Content filtering 182 may refer to a security component that analyzes incoming and sometimes outgoing data streams for undesirable content, such as pornography. In some cases, the content filtering 182 may be used to monitor outgoing communications for classified or confidential information, for example.

Packet filtering 184 may also be performed by the gateway device 174. Packet filtering 184 may refer to a security component that inspects Internet Protocol (IP) packets using various rules. For example, an incoming packet may be verified to determine that it is being sent to a valid address within the local area network and that the packet is being sent from a server with a legitimate address. The incoming packet may be further analyzed to determine that the packet has indeed travelled a plausible route from the sending address to the gateway 174. In many embodiments, such a packet filter may have very sophisticated rules for identifying permissible packets to transfer into the local area network 142.

Many gateway devices 174 may have a logging system 186 that may log incoming and outgoing communications into a database 188. The logging system 186 may gather information about all communications for record keeping and later analysis. In some businesses, an audit trail may be created by the logging system 186 and may be used for offline analysis of any security breech, for identifying security areas that may be further improved, or for other reasons.

In some embodiments, two or more gateway devices may be used. Embodiment 100 shows a second gateway device 190 that may be configured for load balancing or other functions. In some cases, certain types of communications may be routed through one gateway device while other types of communications may be routed through a second gateway device. The security manager 120 may configure the various gateway devices 174 and 190 in response to changes in the security level for the network, which may include load balancing and other functions.

The security manager 120 may manage the security aspects of remote services, which may be any type of service or function that is provided by servers from the wide area network 192. For example, a remote email service 194 may provide messaging services, such as email boxes, to client devices within the local area network 142. The remote mail service 194 may be configured to provide all of the services described for the local email server 154 but through a managed or remotely hosted solution.

The remote mail service 194 may have an authentication mechanism 196 that may operate in conjunction with the domain manager 164 to authenticate various credentials and permit access when those credentials are verified. The configuration of the authentication mechanism 196 may by an example of a security component portion of the remote mail service 194.

The remote mail service 194 may have various content monitoring services 198, malware monitoring services 199, and other security services 197. In some embodiments, such security services may be identical to the security components described for the local email server 154, while in other cases, the security components for the remote email service 194 may be specially adapted or modified for remote applications.

Other remote services 195 may be monitored and managed by the security manager 120. The remote services 195 may be line of business applications, for example, or other applications that may include various security functions 193 and security settings 191.

The active connectors 128 or other components of the security management system may connect to the remote services 195 and configure the settings 191 to meet a defined security level as defined in the predefined configurations 122.

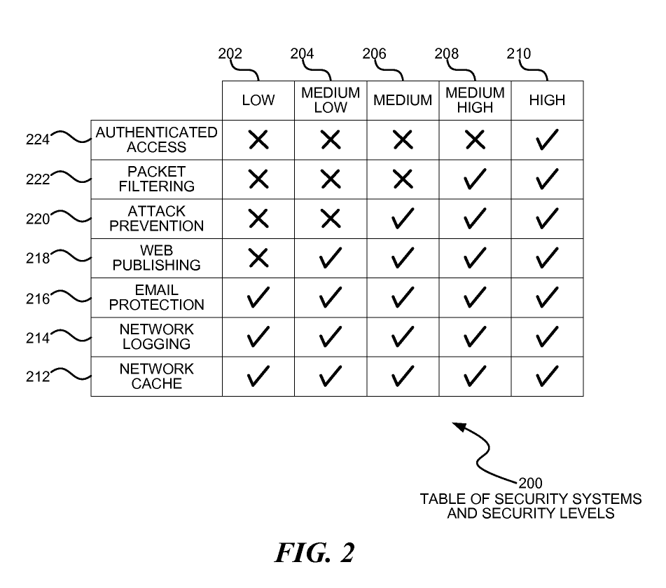

FIG. 2 is a diagram illustration of an embodiment 200 showing a table of security levels and the various security functions represented by the levels.

Embodiment 200 is a simplified example of merely one way a ranked list of security functions may be organized so that a single user interface control, such as a slider mechanism, may be used to configure a wide range of security components on several different devices and for many different services.

The table of embodiment 200 is illustrated as having the security levels as columns in the table. The security levels of low 202, medium low 204, medium 206, medium high 208, and high 210 are illustrated. The rows of the table illustrate various security functions that may be included or not in each of the security levels.

The security functions may represent a security goal or general concept that one or more security components may address. In some cases, a security function may be provided by many different devices, such as gateway devices, remote servers, local servers, and applications operable on client devices all cooperate to address a specific security goal.

The security functions of network cache 212, network logging 214, and email protection 216 are illustrated as being included in all of the security levels from low 202 to high 210. These functions are included in each of the security levels by a security expert as being the lowest acceptable level of protection for a local area network.

The network cache 212 may be a security function that provides caching of all network communications and may minimize or eliminate some network traffic outside of a local area network. Such a function may be provided by a gateway device, local area network server, router appliance, or other service.

The network logging 214 may be a security function that logs network communications between internal and external devices. Such a function may be provided by a security component on a gateway or server device.

The email protection 216 may be a security function that provides several different levels of protection and may be provided by many different security components. For example, email protection may include ensuring that the email originated from the actual sender from which it was alleged to be sent. A security component may quarantine or delete email messages that cannot be verified in this manner. Another security component may verify that the sender is not a known spammer Still another security component may scan the email messages for malware while still another security component may scan the email messages for pornography or other undesirable content. Yet other security components may operate on a client computer and provide additional safety and security for handling email attachments within an email application.

In order to provide the email protection 216 functionality. a security management system may configure many different applications, services, settings, and other functions to provide a cohesive and unified level of security.

The example of embodiment 200 illustrates just a single level of functionality for email protection, even though there may be many different configuration settings and options for such a security function. The configurations represented by the security function “email protection” may represent the best practices or optimized configurations for specific types of networks. For example, a small business network may have a certain level of security that is appropriate, while a home based network may have a different level of security. In such an example, each type of network may operate using a different set of predefined conditions and rules for usage that have been selected and configured by a security expert.

The use of a security expert to define a configuration may take a large burden off of an information technologies generalist. Smaller networks or enterprises may not be able to afford a full time person to specialize in security issues, so a set of predefined configurations and rules for use may provide much if not all of the security configurations that a smaller network may use.

Many networks may have web publishing functions 218, such as remote access to email or files on the network. Some networks may permit remote access to certain devices within the network. In many cases, these remote access scenarios may involve configuring domain controllers, servers, and gateways to provide access for employees or trusted individuals to these services. In some cases, a network may have a website that serves web requests from authenticated users, such as employees, or to the public at large.

The web publishing security function may coordinate the various security components on different devices to permit and monitor access according to the network services being provided.

Attack prevention security function 220 may involve various filters, settings, and other security components to protect against various external threats to a network. In some cases, the attack prevention security function 220 may involve closing off unused ports on a firewall, configuring various checks and monitoring systems, and configuring other security components.

A packet filtering security function 222 may provide several different manners of incoming and outgoing monitoring and checking of IP traffic. Some embodiments may use stateful packet inspection, network layer packet inspection, application layer analysis, and many other forms of traffic inspection and filtering.

Authenticated access security function 224 may configure authenticated access for incoming and outgoing connections. The authentication system may involve configuring various components, such as email services, gateways, and other services to operate with an authentication server when credentials are presented. The authentication system may allow authenticated users to access certain components, and may deny users who are not authenticated.

The various security functions are organized into a ranked list of functions. As the ranked list progresses from email protection function 216 to authenticated action security function 224, the security levels may progress from low 202 to high 210.

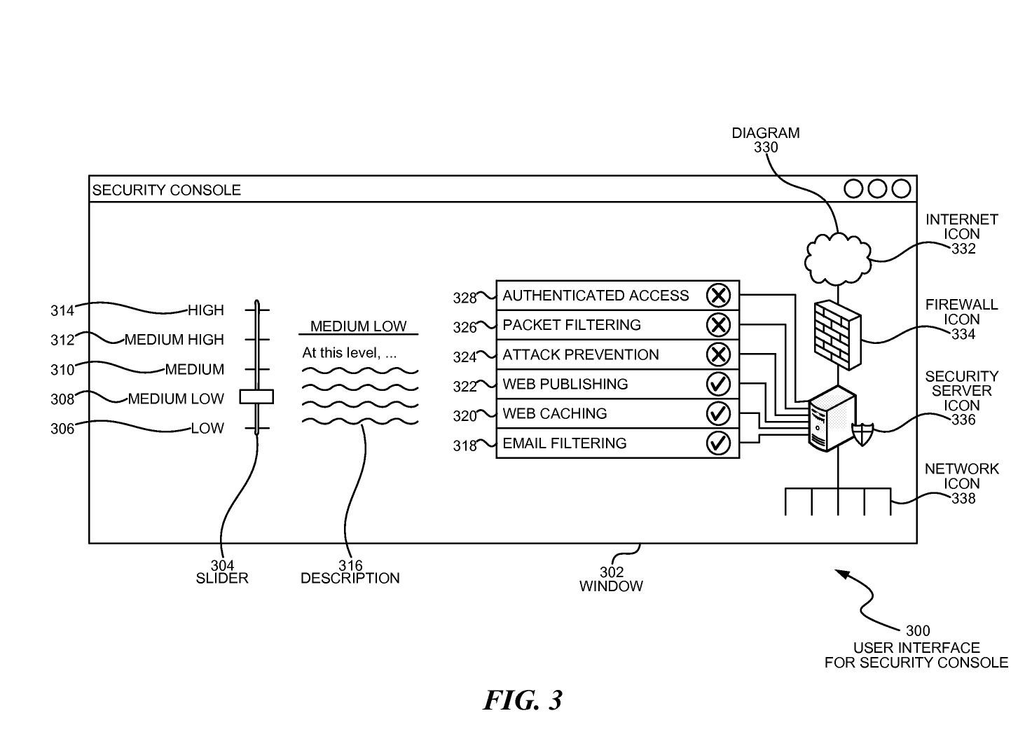

FIG. 3 is a sample illustration of an embodiment 300 showing a user interface for a security console. The illustration of embodiment 300 is merely one example of a user interface screen. Other user interface screens may have different configurations, different layouts, and a different look and feel. Other user interface screens may incorporate other features, display additional data, or incorporate other functions.

The window 302 is an example of a user interface that may be generated by a security console and used to display current configuration status and change the security level of a large number of devices. The window 302 may be used to manage all of the security components on a local area network, including security components on client devices, server devices, gateway devices, and other devices.

The simplified nature of the window 302 may allow an information generalist to configure the security settings from one of five security levels using a slider 304. The levels of low 306, medium low 308, medium 310, medium high 312, and high 314 are displayed along the slider 304. The current position of the slider 304 is medium low 308.

The slider 304 may be one way an administrator may configure multiple security components. The predefined configurations and rules for use for the security components may be organized into security functions, and those security functions may be further organized into a ranked list of security levels. This organization may distill a set of complicated and interacting security components into a simplified set of security levels from which an administrator may select.

The slider 304 may act to display the current security level as well as an input device to cause the security components to be updated.

The current security level may be displayed by the slider 304 after a security collector gathers all of the security component settings. A security manager may determine the lowest security level for which all of the security components are configured. In some cases, an administrator may change the settings of a security component directly, and may either raise or lower the settings.

For example, an administrator may raise the security level to high 314 using the slider 304 and then may change the settings of one security component separately. The administrator may, for example, open a port on a firewall. When the window 302 is generated, the security gatherer may detect the changes as part of collecting the current configuration and the security manager may determine the lowest security level for which all of the security components comply. In other words, the displayed security level can be considered the worst-case security level given the current settings.

By displaying the current configuration as the lowest security level for which all of the security components comply, the slider 304 may give the administrator some feedback about the overall health or security condition of the network. For smaller networks where a dedicated security expert is not available, such an indicator may be useful in helping an administrator identify and correct a security problem.

The window 302 may include a description 316 that may describe the current security level. In many embodiments, the description 316 may offer a concise synopsis of the security level and highlight any factors that may be considered by the administrator for selecting the security level. The description 316 may include a scenario for an appropriate deployment for the security level or other information that may help an administrator who may not have extensive training in security matters.

A list of security functions may be displayed along with a status icon. The window 302 illustrates a list comprising email filtering 318, web caching 320, web publishing 322, attack prevention 324, packet filtering 326, and authenticated access 328. The security functions may correlate with the security functions illustrated in embodiment 200, although in some embodiments, some security functions may not be displayed in the window 302 even though the security functions are incorporated in the predefined configurations for the embodiment.

Each of the security functions are illustrated with icons representing whether or not each security function is properly configured. The icons illustrate that email filtering 318, web caching 320, web publishing 322, and packet filtering 326 are properly configured and operational while attack prevention 324 and authenticated access 328 are not properly operational.

The operational icons may indicate that the security function is either fully functional or that it is not. The not-fully functional condition may reflect that no portion of the security function is configured or that any single element that makes up the security function is not properly configured. The degree of non-functionality may not be reflected in the icon, but the icon may be used to indicate to an administrator that at least some of the functions may not be present.

The window 302 is illustrated with a diagram 330. The diagram 330 may show an Internet icon 332, a firewall icon 334, a security server icon 336, and a network icon 338. The diagram 330 may help the administrator visualize the connections and architecture of the network and may highlight the operational security components of the overall security system. In some embodiments, the various icons may change color or status to reflect operational capabilities or highlight problems that may be addressed by the administrator. Some embodiments may include connection lines between the security functions and the various icons to better highlight the relationships in the security system.

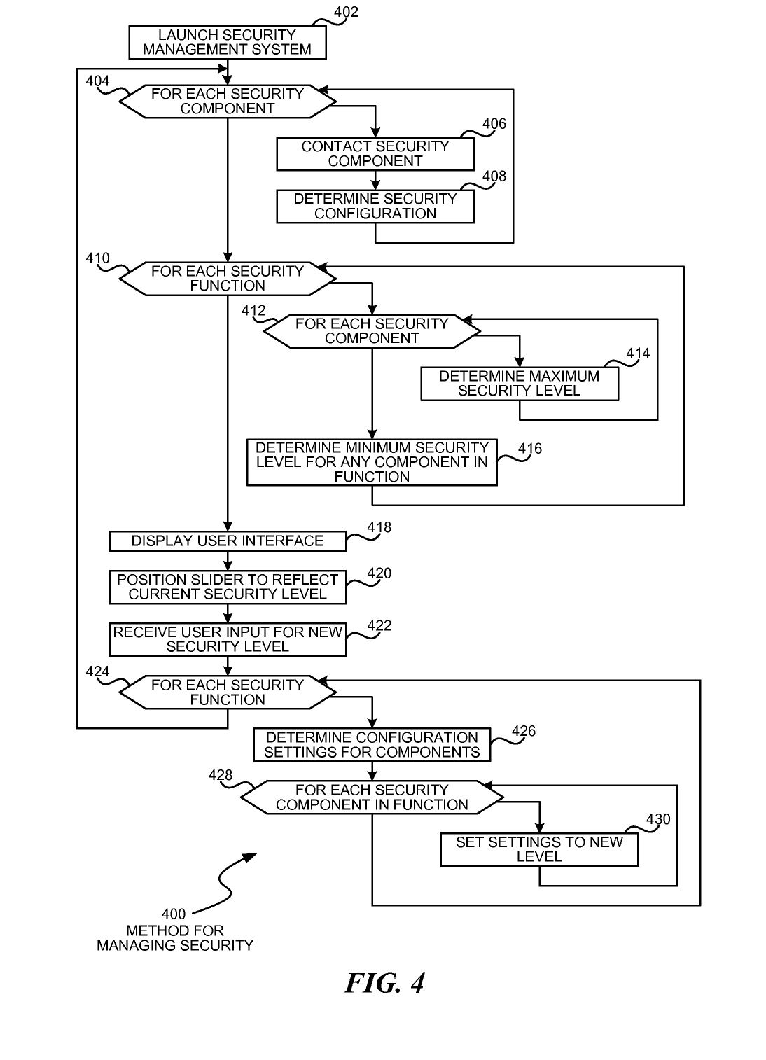

FIG. 4 is a flowchart illustration of an embodiment 400 showing a method for managing security for devices in a network environment. Embodiment 400 is an example of some of the operations that may be performed by a security management system, which may include a security manager, a security collector, and a security console as described in embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The security management system may be launched in block 402.

At the startup of the security management system, the status or configuration of all of the security components may be gathered so that a current security status may be displayed. In block 404, each of the security components may be analyzed by contacting the security component in block 406 and determining a security configuration in block 408. The activities of blocks 406 and 408 may be performed using different mechanisms depending on the security components. For example, in some cases, a configuration file may be read, while in other cases, a query may be made to a running application or a test may be performed to determine if a security component is available and properly configured. Some embodiments may use active connectors which may be scripts, executable programs, or other mechanisms for gathering information from a security component. In some cases, such active connectors may be supplied by a manufacturer of a security component, while in other cases the active connectors may be supplied by the manufacturer of a security management system or even a third party.

After gathering the current status of the security components, the current security level may be determined. The security level may be determined according to the hierarchy or grouping of the security components into security functions. Each security function may be analyzed in block 410. For each security component defined in the security function in block 412, the maximum security level may be determined in block 414. After each security component is analyzed in block 412, the minimum security level of any component is determined in block 416 and that minimum security level may be used as the overall security level for the security function.

After processing each security function in block 410, a user interface may be displayed in block 418 and a slider may be positioned in block 420 to reflect the overall security level. The overall security level may be determined by selecting the minimum security level from a chart such as embodiment 200.

At this point in the process, the user interface may be displayed in a similar manner as the embodiment 300.

A user may create a user input in block 422 that indicates a new slider level. Having received the user input in block 422, each security function may be configured in block 424. The configuration settings for each of the components in the security function may be determined in block 426. For each security component in block 428, the settings may be changed to the new security level in block 430.

After the changes have been made for each security function, the process may return to block 404 so that those changes may be verified in blocks 404 through 416 and displayed in block 420.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method for managing a plurality of security components, said method comprising:
identifying said plurality of security components;
defining a plurality of security levels, each of said security levels comprising a configuration for each of said security components, said security levels being organized on a progressive scale;
analyzing each of said security components to determine a current state for said security components;
determining a first security level based on a security level for which all of said security components are currently configured; and
presenting said first security level on a user interface.

2. The method of claim 1 further comprising:
receiving a selection for a second security level from said user interface;
determining a configuration for each of said plurality of security components, said configuration being defined for said second security level; and
causing each of said plurality of security components to be configured to match said configuration.

3. The method of claim 2 further comprising:
determining that each of said plurality of security components is configured according to said second configuration level; and
presenting said second security level on said user interface.

4. The method of claim 2 further comprising:
determining that a first security component has a configuration defined in a higher security level than said second security level and changing said first security component to said second security level; and
determining that a second security component has a configuration defined in a lower security level than said second security level and changing said second security component to said second security level.

5. The method of claim 1, said security components comprising at least one security application operable on a remote device.

6. The method of claim 5, said security components comprising a firewall device.

7. The method of claim 1, said security components comprising a security setting of an application.

8. The method of claim 7, said application being a web browser.

9. A system comprising:
a processor;
a network interface;
a user interface device;
a predefined security configuration definition for a set of security components comprising:
a plurality of security levels, each of said security levels being defined by a security function, said security function being performed by at least one security component; and
for each of said security components in said set, a configuration setting for each of said plurality of security functions;
a security collector that determines a current configuration setting for each of said plurality of security levels;
a security manager that communicates with each of said security components and determines a current security level from said current configuration setting for each of said plurality of security levels, said current security level being one of said security levels for which every one of said security components is configured; and
a security console that presents said current security level on said user interface, receives a user input from said user interface to change from said current security level to a second security level, and causes said security manager to change a configuration for each of said plurality of security components to meet said second security level.

10. The system of claim 9, said security components comprising applications operating on a gateway located between a local area network and a wide area network, said gateway being separate from said system.

11. The system of claim 10, said security components comprising a logging application operating on said gateway that logs incoming and outgoing communications between said local area network and said wide area network.

12. The system of claim 10, said security components comprising settings of a remote service accessible through said wide area network.

13. The system of claim 12, said settings of said remote service comprising authentication configuration for said remote service.

14. The system of claim 13, said authentication configuration comprising communication with an authentication server within said local area network.

15. The system of claim 10, said security components further comprising a firewall service operable on a client device within said local area network.

16. The system of claim 15, said security components further comprising a web browser setting operable on said client device.

17. A security management system operable on a computer processor of a device connected to a local area network, said security management system comprising:
a predefined security configuration definition for a set of security components comprising:
a plurality of security levels; and
for each of said security component in said set, a configuration setting for each of said plurality of security levels;
for each of said security components, an active connector that reads and sets configuration settings for said security components, said security components comprising:
an email monitoring application operating on an email server that receives email messages and stores said email messages in mailboxes;
a logging application operating on a gateway device through which communications are routed between said local area network and a wide area network; and
a web browser setting for a web browser operating on a client device, said web browser setting defining a set of security settings for said web browser;
a security collector that determines a current configuration setting for each of said plurality of security levels using said active connectors;
a security manager that communicates with each of said security components through said active connectors and determines a current security level from said current configuration setting for each of said plurality of security levels, said current security level being one of said security levels for which every one of said security components is configured; and
a security console that:
presents said current security level on said user interface by positioning a slider indicator on said user interface;
receives a user input from said user interface to change from said current security level to a second security level; and
causes said security manager to change a configuration for each of said plurality of security components to meet said second security level.

18. The security management system of claim 17, said email server being located outside said local area network.

19. The security management system of claim 17, said security manager that further:
receives an updated predefined security configuration from a remote server; and
updates said predefined security configuration to match said updated predefined security configuration.

20. The security management system of claim 17, said security manager that further detects that a first security component has a configuration that is at a different level than said current security setting, and said security console that indicates said first security component having a different setting than said current security level.
